(19) United States
(12) Patent Application Publication
(10) Pub. No.: US 2018/0062208 A1
(43) Pub. Date: Mar. 1, 2018

(54) HORIZONTALLY STACKED LITHIUM-ION THIN FILM BATTERY AND METHOD OF MANUFACTURING THE SAME

(71) Applicant: International Business Machines Corporation, Armonk, NY (US)

(72) Inventors: Ko-Tao LEE, Yorktown Heights, NY (US); Effendi Leobandung, Stormville, NY (US); Ghavam G. Shahidi, Pound Ridge, NY (US)

(21) Appl. No.: 15/246,083

(22) Filed: Aug. 24, 2016

(51) Int. Cl. H01M 10/0585; H01M 10/0525; H01M 10/04; H01M 4/04

(52) U.S. Cl. CPC H01M 10/0585; H01M 10/0525; H01M 10/0436; H01M 2220/30; H01M 4/0426; H01M 4/0492; H01M 4/0428

(57) ABSTRACT

A horizontally stacked configuration of a lithium-ion battery, and a method of manufacturing the same include providing a cathode current collector, depositing a cathode on a top surface of the cathode current collector, and patterning periodic trenches in a top surface of the cathode.

### BACKGROUND

The present invention relates generally to a lithium-ion thin film battery, and more particularly, but not by way of limitation, to a horizontally stacked lithium-ion thin film battery and a method of manufacturing the same.

A lithium-ion battery is a member of a family of rechargeable battery types in which lithium ions move from the negative electrode to the positive electrode during a discharge state and back (i.e., from the positive electrode to the negative electrode) when in a charging state. Li-ion batteries use an intercalated lithium compound as one electrode material, compared to the metallic lithium used in a non-rechargeable lithium battery. The electrolyte, which allows for ionic movement, and the two electrodes are the constituent components of a lithium-ion battery cell.

Thin film lithium ion batteries are a leading candidate for a small battery used in miniature computer, Radio-Frequency Identification (RFID), mobile telephone, sensors, etc. Stacking lithium ion battery can provide higher density in a smaller area.

Conventional stacking techniques vertically stack the lithium-ion batteries which is difficult and expensive because of the use of non-conventional processing, such as bonding, is required.

There is a need in the art to form a lithium-ion battery that may be horizontally stacked.

### SUMMARY

In an exemplary embodiment, the present invention can provide a method of manufacturing a lithium-ion battery, the method including providing a cathode current collector, depositing a cathode on a top surface of the cathode current collector, and patterning periodic trenches in a top surface of the cathode.

One or more other exemplary embodiments include a lithium-ion battery horizontally stacked configuration.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIGS. 1A to 1H are vertical cross-sectional views showing one example of the manufacturing process of a lithium-ion battery 100 according to one embodiment.

FIG. 2 is a vertical cross-sectional view showing one example of a horizontally stacked configuration of the lithium-ion battery 100.

FIG. 3 is a vertical cross-sectional views showing one example of a lithium-ion battery 100 used in the invention.

### DETAILED DESCRIPTION

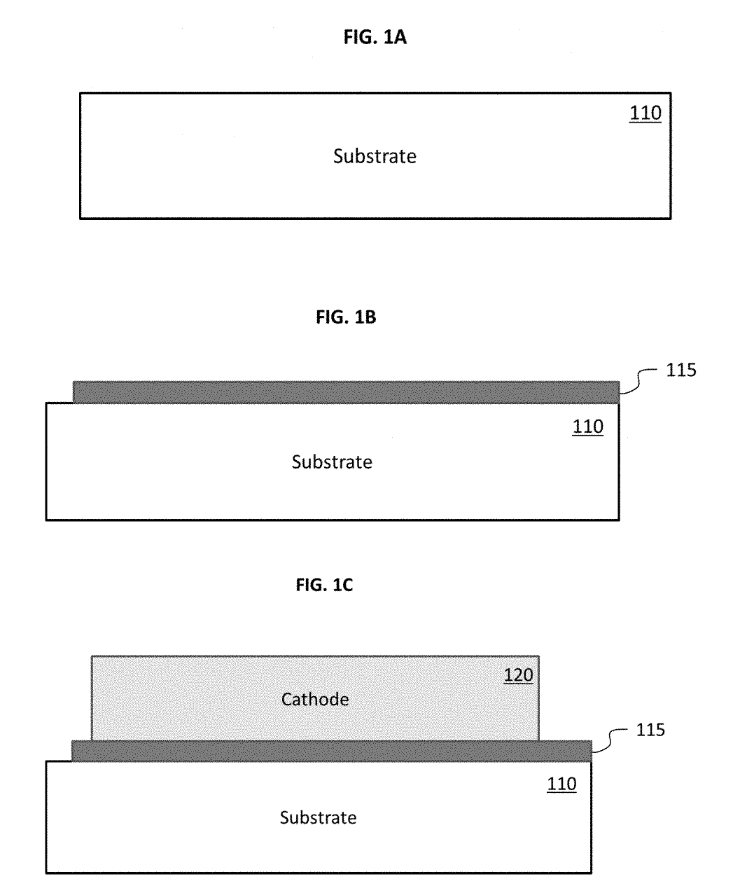

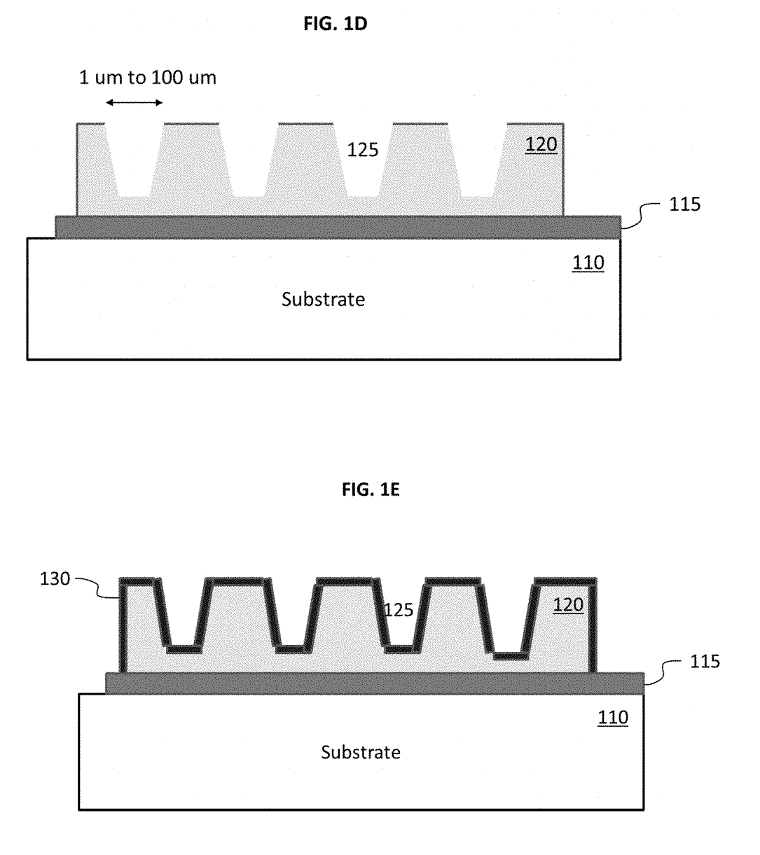

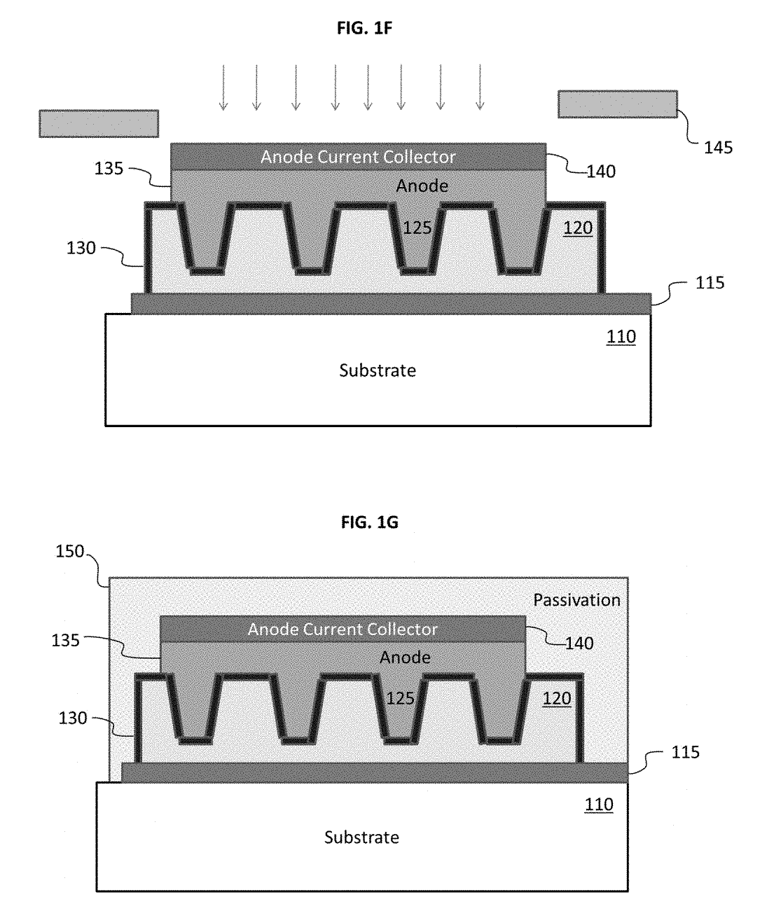

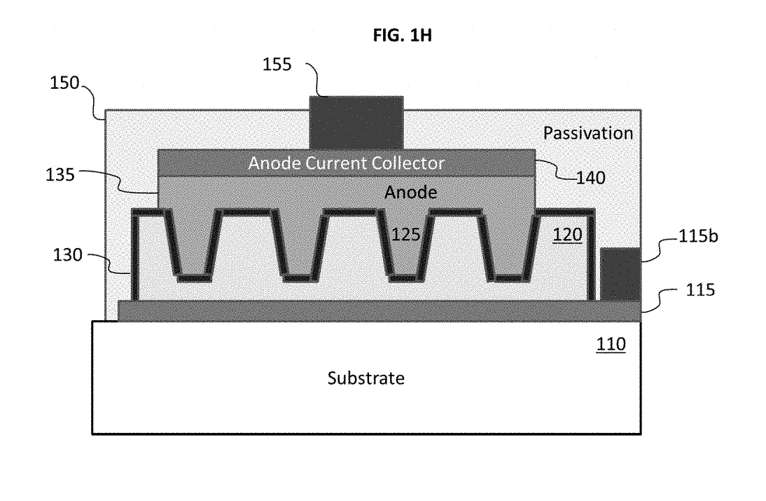

The invention will now be described with reference to FIG. 1-3, in which like reference numerals refer to like parts throughout. It is emphasized that, according to common practice, the various features of the drawing are not necessarily to scale. On the contrary, the dimensions of the various features can be arbitrarily expanded or reduced for clarity.

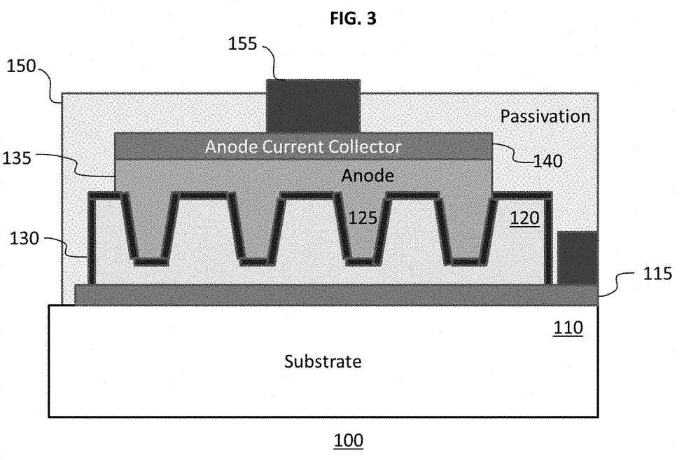

With reference now to the example depicted in FIG. 3, the lithium-ion battery 100 comprises a substrate 110, a cathode current collector 115 stacked on the substrate in a deposition direction, a cathode 120 stacked on the cathode current collector 115 in the deposition direction, a plurality of periodic trenches 125 patterned in the cathode 120, and a conformal electrolyte layer 130 formed on an outer periphery surface area of the cathode 120. In a preferred embodiment, the conformal electrolyte layer 130 is a uniform layer made of as Li₃PO₄ having a thickness preferably in a range of 0.01 μm to 1 μm.

In a preferred embodiment, the substrate comprises any of paper, silicon, glass, polymer, etc. with a thickness of the substrate 110 suitable for mechanical support. The substrate 110 is preferably an insulating material or at least includes an insulating material on a top surface thereof.

In a preferred embodiment, the cathode current collector 115 preferably comprises any metal such as Cu, Al, W, Ti, etc. The thickness of the cathode current collector 115 is preferably in a range of 0.1 μm and 10 μm. The thickness of the cathode current collector 115 is preferably set to reduce resistance and the thickness is a function of the size of the battery. In a more preferred embodiment, the thickness of the cathode current collector is preferably in a range of 1 μm and 2 μm.

In a preferred embodiment, the cathode 120 comprises LiCoO₂, LiNbO₃, carbon material, etc. A thickness of the cathode 120 is preferably in a range of 0.3 μm to 10 μm.

In one embodiment, a width of the trenches 125 is preferably in a range of 1 μm to 100 μm. In a preferred embodiment, the width of the trenches 125 is in a range of 1 μm to 50 μm. A depth of the trenches 125 in the cathode 120 is preferably in a range of 30% to 90% of a height of the cathode 120. A pitch of the trenches 125 is preferably equal to a width of the trenches 125. Preferably, the trenches 125 have a truncated V-shape.

In a preferred embodiment, a thickness of the electrolyte is in a range of 0.01 μm to 1 μm. The electrolyte 130 comprises Li₃PO₄ or the like.

As exemplary shown in FIG. 3, the Lithium-ion battery 100 comprises an anode layer 135 deposited on the electrolyte layer 130 and in the trenches 125. A width of the anode layer 125 is preferably less than a width of the cathode 120. An anode current collector 140 is deposited on the anode 135 in the deposition direction. Preferably, a width of the anode current collector 140 is substantially equal to a width of the anode 135. In a preferred embodiment, a width of the anode 135 is in a range of 1 μm to 100 μm.

In some embodiments, the anode 135 comprises Li or the like and the anode current collector 140 comprises a metal such as W, Cu, Au, Ti, etc.

The lithium-ion battery 100 comprises a passivation layer 150 encapsulating the anode current collect 140, the anode 135, the electrolyte layer 130, the cathode 120, and the cathode current collector 115. The passivation layer may comprise any of SiO₂, SiN, a polymer, etc. In some embodiments, a portion of the substrate 110 is exposed from the passivation layer 150. In some embodiments, an edge surface of the cathode current collector 115, the substrate 110, and the passivation layer are flush (e.g., right edge shown in FIG. 3).

The lithium-ion battery further comprises a contact 155 patterned in the passivation layer for the anode current collector 140, and the cathode current collector 115. The contact 155 is exposed from the passivation layer.

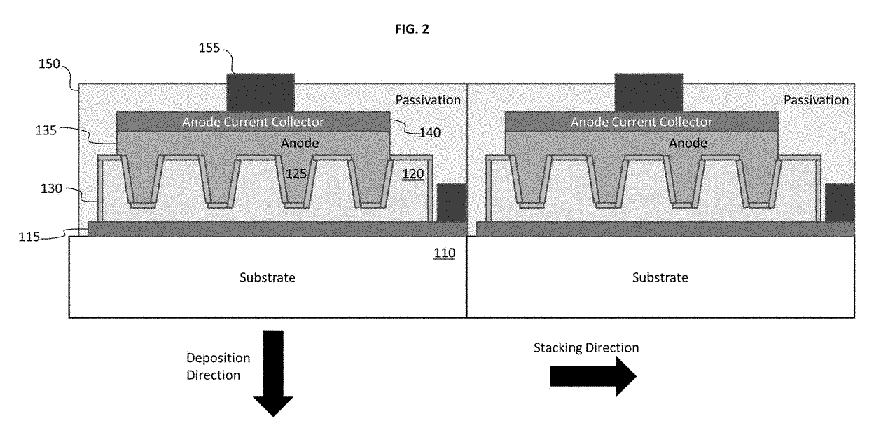

Referring now to FIG. 2, a horizontally stacked configuration of the lithium-ion battery is exemplarily shown. The lithium-ion batteries are horizontally stacked in a stacking direction. That is, the batteries are orthogonally stacked in a direction to the deposition direction. Such horizontally stacking provides increased battery capacity and provides higher density in a smaller area.

Referring now to FIGS. 1A to 1H, a method of manufacturing the Lithium-ion Battery 100 will be discussed.

First, as shown in FIG. 1A, a substrate 110 is provided.

Next, as shown in FIG. 1B, a cathode current collector 115 (which can be any metal) is deposited on a top surface of the substrate 110. The cathode current collector 115 may be deposited such that a portion of the top surface the substrate 110 is not covered (e.g., exposed). That is, a width of the cathode current collector 115 may be less than the substrate 110 or multiple current collector can be made on one substrate.

Next, as shown in FIG. 1C, a cathode 120 is deposited on the cathode current collector 115. Deposition may be performed by sputtering chemical vapor deposition (CVD), etc. In some embodiments, the cathode 120 may be annealed after deposition. A width of the cathode 120 is less than a width of the cathode current collector 115.

As shown in FIG. 1D, periodic trenches 125 are patterned into the cathode 120. In some embodiments, the patterning can use lithography with either wet etching (HF/HNO₃) for LiNbO₃ or other wet etches. In another embodiment, the periodic trenches 125 can be patterned using dry etching such as plasma etching, Ion Mill with Resist or Ion Mill Mask. For example, CF₄/He Plasma cycle with wet clean (70% H2O, 20% H2O@, 10% NH₄OH) may be used.

The periodic trenches 125 are patterned such that an edge portion exists between the outermost trenches of the periodic trenches 125 and the edge surface of the cathode 120. An anneal steps can be performed to anneal the cathode if necessary.

Next, as shown in FIG. 1E, a conformal electrolyte 130 is depositing on the cathode 120 and in the trenches 125 with a conformal process such as metal organic chemical vapor deposition (MOCVD). In a preferred embodiment, the conformal electrolyte 130 is uniformly deposited.

Next, as shown in FIG. 1F, an anode 135 and an anode current collector 140 is deposited under vacuum using an evaporation mask 145.

Next, as shown in FIG. 1G, a passivation layer 150 is deposited without breaking the vacuum of the structure in FIG 1F.

Next, as shown in FIG. 1H, the passivation layer 150 is patterned to make an anode contact 155a and a cathode current collector contact 115b.

The above exemplary configurations of the present invention may provide a horizontal stacking configuration to increase battery capacity and reduce the size of the battery. Also the fabrication cost will be cheaper and easier compared to vertical stacking process using bonding. It also increases the surface area of the anode which increase the charging and discharging rate of the battery.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A method of manufacturing a lithium-ion battery, the method comprising:
providing a cathode current collector;
depositing a cathode on a top surface of the cathode current collector; and
patterning periodic trenches in a top surface of the cathode.

2. The method of claim 1, further comprising depositing the cathode current collector on a top surface of a substrate.

3. The method of claim 1, further comprising annealing the cathode after the cathode is deposited on the cathode current collector.

4. The method of claim 1, further comprising depositing a conformal electrolyte on an entirety of the top surface of the cathode and the periodic trenches.

5. The method of claim 4, wherein the conformal electrolyte is deposited on the cathode and in the periodic trenches to have a uniform thickness.

6. The method of claim 4, wherein the conformal electrolyte comprises a uniform thickness in a range of 0.1 μm to 1 μm.

7. The method of claim 4, further comprising:
under vacuum, depositing an anode on the conformal electrolyte and in the periodic trenches; and
under the vacuum, depositing an anode current collector on a top surface of the anode.

8. The method of claim 7, wherein the depositing the anode and the depositing the anode current collector is performed using an evaporation mask.

9. The method of claim 7, wherein a thickness of the anode is in a range of 1 μm to 100 μm.

10. The method of claim 7, further comprising depositing a passivation layer to encompass the anode current collector, the anode, the conformal electrolyte, and the cathode current collector without breaking the vacuum.

11. The method of claim 10, wherein an edge surface of the passivation layer and an edge surface of the cathode current collector are flush with each other.

12. The method of claim 10, further comprising patterning the passivation layer to make a first contact for the anode current collector and a second contact for the cathode current collector.

13. The method of claim 12, wherein the first contact and the second contract are exposed from the passivation layer.

14. The method of claim 1, wherein a thickness of the cathode current collector is in a range of 0.1 μm to 10 μm.

15. The method of claim 1, wherein a width of each of the periodic trenches is in a range of 1 μm to 100 μm.

16. The method of claim 1, wherein a depth of each of the periodic trenches is in a range of 30% to 90% of a height of the cathode.

17. The method of claim 1, wherein a distance between each of the periodic trenches is equal to a width of one of the periodic trenches.

18. The method of claim 1, wherein a width of the cathode is less than a width of the cathode current collector.

19. A lithium-ion battery comprising:
a cathode current collector;
a cathode deposited on a top surface of the cathode current collector, the cathode having periodic trenches patterned into a top surface of the cathode;
a conformal electrolyte layer deposited on an entirety of the top surface of the cathode;
an anode deposited on the conformal electrolyte layer and in the periodic trenches;
an anode current collector deposited on a top surface of the anode;
a passivation layer encompassing the anode current collector, the anode, the conformal electrolyte, and the cathode current collector;
a first contact patterned into the passivation layer for the anode current collector; and
a second contact patterned into the passivation layer for the cathode current collector.

20. A horizontally-stacked configuration of at least two lithium-ion batteries, the horizontally stacked configuration comprising:
first and second lithium-ion batteries, each comprising:
a cathode current collector;
a cathode deposited on a top surface of the cathode current collector, the cathode having periodic trenches patterned into a top surface of the cathode;
a conformal electrolyte layer deposited on an entirety of the top surface of the cathode;
an anode deposited on the conformal electrolyte layer and in the periodic trenches;
an anode current collector deposited on a top surface of the anode;
a passivation layer encompassing the anode current collector, the anode, the conformal electrolyte, and the cathode current collector;
a first contact patterned into the passivation layer for the anode current collector; and
a second contact patterned into the passivation layer for the cathode current collector.
